(19) United States
(12) Patent Application Publication
(10) Pub. No.: US 2009/0176392 A1
(43) Pub. Date: Jul. 9, 2009

(54) Decor and safety cover panel for electrical outlets

(76) Inventor: Steve F. Moore, Greenwood Village, CO (US)

Correspondence Address: Leyendecker & Lemire, LLC, C/O PORTFOLIO IP, P.O. BOX 52050, MINNEAPOLIS, MN, 55402, US

(21) Appl. No.: 11/699,055

(22) Filed: Jan. 29, 2007

(51) Int. Cl. H01R 13/44

(52) U.S. Cl. 439/148

(57) ABSTRACT

A simple, one piece, inexpensive flat panel with beveled edges that plugs into unused electrical outlets and camouflages the receptacle and faceplate and creates a safety barrier to the electrical components of an unused electrical outlet is described. The panel comprises a solid panel of non-conductive molded material, slightly larger than a standard faceplate, with a paintable surface on the outside and, on the underside, posts positioned to fit into the orifices of an electrical socket. The panel fits over the outlet's faceplate and is “plugged” into the socket, requiring no tools to install or remove. It has a paintable surface which can be covered with paint used on the surrounding walls camouflaging unused outlets. It can be moved and repainted as the room's decor changes. The painted panel serves as a barrier to the electrical mechanism making it less pronounced.

### FIELD OF THE INVENTION

The present invention relates to interior decor and safety, and, more particularly, to a one-piece, panel that plugs into unused electrical outlets, over the faceplate.

### BACKGROUND OF THE INVENTION

Unused electrical outlets are unsightly and are an unsafe attractive nuisance.

Homes and commercial buildings have many more electrical outlets than are needed because current building codes in the United States require that there be no longer than a six foot floor run to an available electrical outlet. Consequently, contemporary homes and commercial buildings and older homes and commercial buildings that are remodeled and meet current building codes have many excess electrical outlets. These unused electrical outlets distract from the decor of a room because they do not blend with the paint color of the walls. And, the increased number of electrical outlets simply provides increased opportunities for the occupants of a room to come in contact with electrical hazards.

Standard electrical outlets are comprised of a white socket mechanism and a white faceplate. Contemporary homes have walls painted with off white, pastel, or rich dark colors. White electrical outlets, spaced frequently along a wall, contrast and distract from the uniform appearance of the painted wall and become very noticeable because they do not blend with the wall. The increased number of unused outlets, combined with the fact that they stand out from the wall, creates an increased number of unsafe attractive nuisances and increases the risk of human exposure to active electrical elements. Occupants of a room are confronted with these excess electrical outlets and find them to be a visually unpleasant and potentially hazardous.

Devices exist to either improve the appearance of electrical outlets or provide a safety barrier to humans, however, no product exists that accomplishes both.

Decor enhancing devices exist for electrical outlets which replace the faceplate to make the “socket” portion of an electrical outlet more visually appealing, or to conceal unsightly screws, or provide an appealing frame to an outlet. All decor related devices provide access to the electrical components of the wall socket and are not intended to reduce hazard.

In U.S. Pat. No. 7,119,278, a cover plate exists that is thin and rectangularly shaped, with apertures to receive plug blades, which replaces the faceplate and is attached to the socket mechanism with a screw. This device addresses the problem of paint buildup on the electrical socket after many years of redecorating and repainting. Although faceplates can easily be removed during wall painting, the socket itself is considered permanent and is subject to being defaced from dripping or spattering paint. This device makes the outlet more aesthetically pleasing by providing a thin flat mask, that maintains the outlet's functionality, that, prior to wall painting, can be removed by unscrewing the center set screw, and reinstalled when paint is dry, covering any paint that has accidentally spattered onto the original, permanent outlet socket. These cover plates are available in a variety of manufacturer selected colors. A screwdriver is required for its use.

In U.S. Pat. No. 4,676,570, a cover plate exists to replace a standard faceplate, which is attached with a center screw, with a plate that attaches to the electrical socket using concealed flanges for a “snap fit” to the outlet. The purpose of this device is to cover unsightly screws.

In U.S. Pat. No. 6,664,471, a removable socket cover exists, consisting of a panel and sidewalls, for the purpose of temporarily protecting the socket and wiring from paint drips and spatters during a painting project. It is installed by pressing it into place while painting a wall in the immediate proximity of the socket and then is removed and reinstalled over a different socket, as the painting progresses.

Safety cover devices restrict access to the electrical components of the wall socket through the use of overlay parts or enclosures. Electrical outlets for supplying electrical power to appliances and machines are common fixtures in homes and buildings. A persistent danger associated with electrical outlets is that children may insert their fingers or other objects into the openings of electrical outlets and be injured of killed or may cause injury to their surroundings. This is a particular risk when nothing is plugged into the openings of outlets, making them inviting targets for children's curiosity.

In U.S. Pat. No. 7,094,969 and U.S. Pat. No. 6,159,034, safety related devices exist that cover electrical outlets and sockets by attaching a pivoting, hinged or sliding door apparatus. This device is oversized in length, width, and depth and protrudes from the wall and requires a tool for the removal of the existing face plate.

In U.S. Pat. No. 6,309,239, attaching a hinged boxlike plug enclosure covers provides a barrier to the electrical outlet. This device is oversized in length, width, and depth and protrudes from the wall and requires a tool for the removal of the existing face plate.

In U.S. Pat. No. 6,051,788, attaching a thick faceplate that prevents simultaneous contact of the fingers of a person holding a plug with the bare metal prong as it contacts the receptacle's electrical contacts. This device is oversized in length, width, and depth and protrudes from the wall and requires a tool for the removal of the existing face plate.

Other safety devices are small, about the size of a quarter, and cover only the orifice area of the socket. They are attached by being inserted into the active, “hot” orifices of the electrical mechanism, blocking access to the receptacle's electrical mechanism.

Many devices have been created to enhance the appearance of electrical outlets, but they provide no safety barrier between the electrical mechanism and the occupants of a room and require tools for installation and reinstallation, and most require the removal of the faceplate.

One device, that replaces a faceplate, sites a primary objective as hiding the screws that secure the device to the wall using adaptors with openings that allow the decorative cover to snap into place. This snap-on method, however, requires costly manufacturing processes and may be too expensive for the average homeowner. These cover plates provide a “snap fit” with a corresponding flange. Typically, one or both of the flange portions, and the corresponding elements, must bend somewhat to engage the cover plate. This configuration is troublesome because it is difficult to remove the cover plate and each removal and reengagement produces some bending and fatigue. Repeated removal and reengagement can lead to damage and possibly failure of the device.

Other cover plates mount over the electrical socket, after removal of the faceplate, and have apertures for plug blades and a center hole for receiving a screw to secure it to the socket. The intent of this device is to replace the faceplate and cover the entire outlet, with openings only the size of plug blades, unlike a faceplate which only masks the wall opening and wiring associated with the socket. The cover will mask any paint that has spattered or dripped onto the socket, but is only available in colors selected by the manufacturer, which will not exactly match a wall's paint color or will have to be changed if the paint color of the wall changes. This device requires tools to install and does not eliminate the need for unattractive screws.

Many devices have been created to limit children's access to the openings in electrical outlets, but they are unsightly and detract from room decor and require tools to install and reinstall.

Boxlike outer covers that lock over a base plate, with hinged, doorlike openings for passage of an electric cords offer substantial protection, however, they are unsightly and it may be prohibitively expensive to use these devices for every outlet in the home or building. A stop bar blocks access to the outlet by children, and the locks on the device are covered by the outer cover and can be released only by an external, magnetic force. If an electrical hazard develops and a user needs to quickly open the outlet cover, they must first have the device providing the magnetic force available, in order to open the door and disengage the plug from the socket. It is critical for safety that it be readily openable by an adult.

Covers with sliding or swinging “doorlike” parts that cover the orifices of an electrical socket, or devices where the entire cover slides or swings out of place provide protection from hazard but the complexity of these safety covers and the difficulty of use, as well as the space required, particularly when opened, limits their practicality. This type of safety cover uses a variety of parts that are most apt to be lost, suffer breakage, and which require an inordinate amount of time to install, and are complex and expensive to procure.

Plastic safety plugs with prongs that fit snugly into openings are readily available, however, being visible, safety plugs may themselves be taken as a challenge for removal by some children. These small safety plugs are a hazard to children as they are small enough for a child to put it into its mouth. Additionally, the small, pronged plugs, installed in a socket may be a tempting challenge to a child who sees it as a toy.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a topside perspective view of a cover panel according to an embodiment of the present invention; and

FIG. 2 is an underside perspective view of a cover panel according to an embodiment of the present invention.

For purposes of clarity and brevity, like elements and components will bear the same designations and numbering throughout the Figures.

### DESCRIPTION OF THE PREFERRED EMBODIMENT

In accordance with embodiments of the present invention, there is provided a simple, one piece, inexpensive panel, that camouflages unused electrical outlets (socket and faceplate) and creates a safety barrier to the electrical components of an electrical socket. It is a single product that has a dual purpose. It comprises a lightweight, solid panel, larger than a standard double outlet faceplate, with a paintable surface on the outside and, on the underside, a plurality of posts shaped and positioned to fit into the orifices of an electrical socket. Installation does not require the removal of the faceplate. The panel fits over the outlet's faceplate and is “plugged” into the electrical socket, requiring no screws or tools to install, remove, and reinstall. It has a paintable surface which can be covered with the paint used on the surrounding walls making the unused outlet blend with the wall to improve the appearance of the room. It can be moved and repainted as the room's decor changes. The painted panel serves as a barrier to potential electrical hazard and discourages, by making it less pronounced.

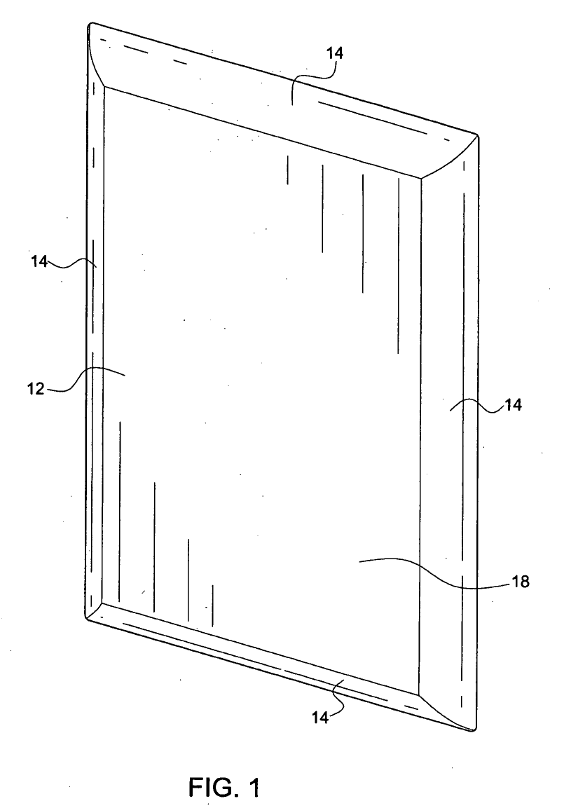

FIG. 1 is a perspective view of the top side of the cover panel in accordance with the invention. This embodiment has dimensions are larger than the dimensions of the faceplate of a standard wall outlet. This embodiment is molded with a resin, or similar material, that has paint bonding characteristics, giving it a paintable surface that is intended to be painted with the same paint that has been used on the surrounding walls making it an exact color match to the walls. The beveled edge 14 around all four sides, which convexly curve from the panel surface, allow the cover panel to cover the electrical outlet, including the faceplate, from view from the left, right, top, and bottom. This embodiment is a solid panel 12, with no moving parts, seams, or joints, of non conductive material 18, which is molded Acrylonitrile Butadiene Styrene, or ABS, or any other suitable non conductive material 18, which will provide a barrier to, and insulate the occupants of the room from, the electrical mechanism of the outlet.

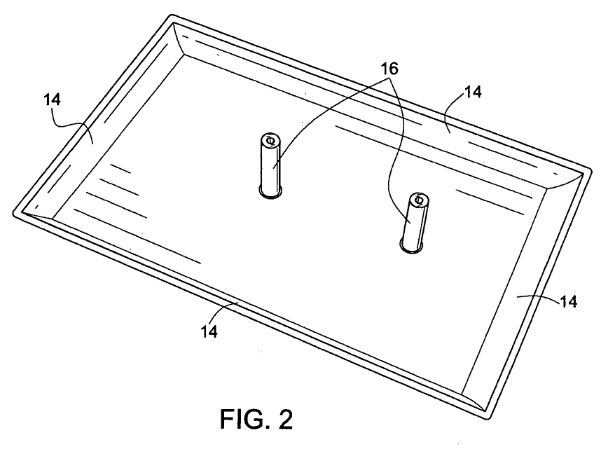

FIG. 2 is a perspective view of the underside of the cover panel. This embodiment has an underside with said beveled edge 14 in a concave fashion, allowing it to be placed over a standard outlet faceplate and conform to the shape of the faceplate. This embodiment has the depth required to encase a standard double wall outlet faceplate. The underside exposes a protruding dual post set 16, formed perpendicular to the panel, shaped to conform with the [[the]] size and depth, and positioned to correspond with the location, of certain orifices of a standard electrical socket. Said dual post set 16 fits snuggly when inserted into the electrical socket's corresponding orifices and provides a secure means of attaching to the outlet. Said dual post set 16 is positioned such that it is defined and that it is alignable with a corresponding orifice in a standard electrical socket.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1.-6. (canceled)

7. A panel for covering one or more electrical outlets and an associated faceplate, the panel comprising:
a plate portion having (i) a substantially planar and continuous front surface on a front side of the panel and (ii) a back surface on a back side of the panel spaced from the front surface, the plate portion being bounded by and interfacing with top, bottom, left and right beveled edge portions; and
one or more protrusions extending from the back surface, the protrusions adapted for receipt into plug receptacles of the one or more electrical outlets;
wherein the plate portion, and the top, bottom left and right edge portions for a cavity on the back side, the cavity being adapted to cover and substantially enclose the faceplate against a wall on which the one or more electrical outlets and face plate are mounted.

8. The panel of claim 8, wherein the panel is molded as a single unit of a non-conductive material.

9. The panel of claim 7, wherein wall paint is capable of adherence on the front side.

10. The panel of claim 7, wherein the one or more protrusions comprise two protrusions each adapted for receipt into plug receptacles of one of more associated electrical outlets.

11. The panel of claim 7, wherein each of the front surfaces of the top, bottom, left and right beveled edge portions are convex.

12. The panel of claim 11, wherein each of the back surfaces of the top, bottom, left and right beveled edge portions are concave.

13. The panel of claim 8, wherein the panel is substantially comprised of a non-conductive resin material.

14. The panel of claim 13, wherein the resin material comprises Acrylonitrile Butadiene Styrene.

15. The panel of claim 7 wherein the front side is painted with wall paint.

16. The panel of claim 7 in combination with a wall, the wall having a first electrical outlet and a second electrical outlet of the one or more electrical outlets surrounded by the associated faceplate, wherein a first protrusion of the one or more protrusions is received in a first plug receptacle of first electrical outlet and a second protrusion of the one or more protrusions is received in a second plug receptacle of second electrical outlet with the cavity enclosing the associated faceplate against a surface of the wall.

17. The combination of claim 16, wherein the front side and a surface of the wall are covered in paint of a similar color.

18. A decor and safety cover panel for a pair of electrical outlets and an associated standard double wall outlet faceplate, the panel comprising:
a plate portion having front and back plate surfaces;
beveled portions surrounding the plate portion also forming front and rear beveled surfaces, the front plate and beveled surfaces forming a solid contiguous front, and the rear plate and beveled surfaces forming cavity adapted to encase the standard double wall outlet faceplate when installed; and
plug-like protrusions extending from the rear plate surface, the protrusions adapted to be received into receptacles of the electrical outlets.

19. The cover panel of claim 18, wherein the cover panel is molded from a non-conductive resin as a unitary piece.

20. The cover panel of claim 19 wherein the resin comprises Acrylonitrile Butadiene Styrene.

21. The cover panel of claim 18, wherein the cover panel is substantially rectangular.

22. The cover panel of claim 18, wherein the front surfaces of the beveled edges are convexly-shaped.

23. The cover panel of claim 22, wherein the back surfaces of the beveled edges are concavely-shaped.

24. A unitarily molded decor and safety cover panel comprising Acrylonitrile Butadiene Styrene for a pair of electrical outlets and an associated standard double wall outlet faceplate, the panel comprising:
a plate portion having front and back plate surfaces;
beveled portions surrounding the plate portion also forming front and rear beveled surfaces, the front beveled surfaces being substantially convex and the rear beveled surfaces being substantially concave, the front plate and beveled surfaces forming a solid contiguous front, and the rear plate and beveled surfaces forming cavity adapted to encase the standard double wall outlet faceplate when installed; and
a pair of plug-like protrusions extending from the rear plate surface, each protrusion adapted to be received into a receptacle of one of the electrical outlets.

25. The panel of claim 24, wherein the front surfaces of the beveled portions and the plate portions are painted with wall paint.

26. The panel of claim 24 in combination with a wall, the wall having the pair of electrical outlets and the associated faceplate mounted thereon, wherein a first protrusion of the pair of plug-like protrusions is received in a first plug receptacle of one electrical outlet and a second protrusion of the pair of protrusions is received in a second plug receptacle of the other electrical outlet with the cavity enclosing the associated faceplate against a surface of the wall.
